(19) United States
(12) Patent Application Publication
(10) Pub. No.: US 2025/0362955 A1
(43) Pub. Date: Nov. 27, 2025

(54) DEVICE FOR DEVICE FOR DISTRIBUTED SEMANTIC PROCESSING AND COMMUNICATION, AND METHOD OF OPERATING THE SAME

(71) Applicant: HUAWEI TECHNOLOGIES CO., LTD., Shenzhen (CN)

(72) Inventors: Abdellatif Zaidi, Boulogne Billancourt (FR); Piotr Krasnowski, Boulogne Billancourt (FR); Milad Sefidgaran, Boulogne Billancourt (FR)

(73) Assignee: HUAWEI TECHNOLOGIES CO., LTD., Shenzhen (CN)

(21) Appl. No.: 19/295,194

(22) Filed: Aug. 8, 2025

Related U.S. Application Data
(63) Continuation of application No. PCT/EP2023/053216, filed on Feb. 9, 2023.

(51) Int. Cl. G06F 9/48

(52) U.S. Cl. CPC G06F 9/4881

(57) ABSTRACT

A device for distributed semantic processing and communication is operable as a child device and/or a parent device in a parent-child hierarchy of devices. The device semantically processes input data based on a local context and a local goal. The input data originates from one or more sensors or one or more child devices of the device. The device maintains the local context based on the semantically processed input data and available side information. The device also participates in an assignment of respective local goals of the devices across the parent-child hierarchy based on the local context.

### CROSS-REFERENCE TO RELATED APPLICATIONS

This application is a continuation of International Application No. PCT/EP2023/053216, filed on Feb. 9, 2023, the disclosure of which is hereby incorporated by reference in its entirety.

### FIELD

The present disclosure relates generally to the field of semantic in-network learning, and in particular to a device for distributed semantic processing and communication, as well as to a method of operating the same.

### BACKGROUND

An increasing number of applications and services, such as robotics, autonomous driving, traffic management, and smart factory, rely on techniques such as object recognition and computer vision. In these applications and services, multiple distributed sensors gather information about the environment in order to enable some complex decision-making at a control center. However, due to the growing amount and/or complexity of sensor data to be transmitted by the sensors and processed by the control center, efficient decision-making becomes a very challenging task.

A promising direction is processing the sensor data at a semantic level, e.g. by focusing on the intended meaning of the sensor data rather than on its exact representation. Providing semantic interpretations of the sensor data instead of sending direct measurements (or raw sensor data) to the control center may significantly reduce communication costs and reduce latency, which facilitates the decision-making at the control center.

Though, the problem of distributed semantic inference, especially in mobile scenarios, is still not well studied. The few existing methods suffer from several disadvantages. Firstly, they do not allow semantic interpretation (or semantic reasoning on the usefulness) of their input data with regard to a global goal and/or semantic fusion of semantic interpretations obtained separately from multiple sources/sensors in order to obtain richer semantic representations. Secondly, they do not consider a variable number of mobile devices collecting multi-modal data. Thirdly, they do not take into account variable context that is caused by the mobile devices' mobility.

### SUMMARY

According to a first aspect, a device for distributed semantic processing and communication is provided. The device is operable as a child device and/or a parent device in a parent-child hierarchy of devices. The device is configured to semantically process input data in dependence of a local context and a local goal. The input data originates from one or more sensors or one or more child devices of the device. The device is further configured to maintain the local context in dependence of the semantically processed input data and available side information. The device is further configured to participate in an assignment of respective local goals of the devices across the parent-child hierarchy in dependence of the local context.

Advantageously, the parent-child hierarchy of devices supports a variable number of devices.

Advantageously, maintaining local goals and local context improves a robustness to dynamic changes of the pattern of views, and does not require costly re-training or re-calibration whenever the topology/hierarchy changes.

Advantageously, the devices remain silent whenever no relevant information has been observed, and provide data only when relevant information has been detected. This intermittent communication allows to reduce the average communication rate by orders of magnitude, reduce communication costs, enhance privacy and significantly improve performance (e.g., lower latency, robustness, flexibility, and energy consumption) compared with previous techniques for distributed inference, such as plain In-Network Learning (INL) or Split Learning (SL).

As used herein, semantic (data) processing may refer to processing of data, such as sensor data, at a semantic level, e.g. by focusing on its intended meaning rather than its exact representation.

As used herein, semantic communication may refer to communication in accordance with a semantic language.

As used herein, a semantic language may refer to a structured system of communication, such as a logic-based language or a graph-based language.

As used herein, a goal may refer to an intended finding of the distributed semantic processing and communication. A local goal may relate to a particular device of the parent-child hierarchy of devices. A goal may be expressed using a suitable compositional semantic language. More specifically, a superordinate (e.g., global) goal may be composed of—or decomposed into—sub (ordinate) goals. For example, G0=φ1∨φ2 may define a goal G0 being composed of and being decomposable into sub-goals φ1 and φ2, wherein “∨” represents a logical OR operation. In this example, φ1 may denote “there is a moving car on the pedestrian area”, and φ2 may stand for “there is a person holding a gun”. Global and local goals may be expressed using a varying level of semantic abstraction. For example, monitoring “vehicles” could be further decomposed to monitoring “cars”, “bikes”, “buses”, etc. A local goal may involve a processing/computing function which is configured to store and maintain the local goal.

As used herein, a local goal may refer to a portion of a superordinate (e.g., global) goal relating to a particular device in the parent-child hierarchy of devices.

As used herein, a parent device may refer to a superordinate device of one or more child devices in a parent-child hierarchy of devices.

As used herein, a child device may refer to a subordinate device of a parent device in a parent-child hierarchy of devices.

As used herein, local context may refer to information about an observed environment and a state of a device within the parent-child hierarchy of devices. Context may serve to properly interpret input data and to assign goals to child devices. For example, context may include built-in or learnt background knowledge, sensor parameters (type, position, etc.), general settings (weather, time, holidays, etc.), current pattern of views, a position of the device with respect to other devices, partial semantic information provided by other devices (including already detected objects with attributes), and the like. Context may constantly evolve due to mobility of devices and due to changes in the observed environment. Possible events causing significant changes of context include devices getting in/out of the parent-child hierarchy of devices, changed relative pattern of views (e.g., caused by rotation of a sensor), displacement of one or more sensors into a new area (e.g., from a street to a park), change in the capabilities of the device (e.g., low battery), significant changes in the environment (e.g., intensive rain, diurnal changes, etc.) and the like. That is to say, context may become outdated relative to the “true” information about the observed environment and the state of the device. Hence, a discovery/update/sharing of context may be relevant. When a parent device detects a significant change in local context, it may thus share updated context with its child devices and update the sub-goal assignment. When a child device detects a significant change in local context, it may share updated context with its parent device. Local context may involve a processing/computing function which stores and evaluates the same.

As used herein, side information may refer to global contextual information not being directly observable from raw data collected by the sensors, in particular information about the state of the parent-child hierarchy of devices, such as a number of registered devices, their geographic positions/locations, their battery levels, a network topology, computational capabilities of the devices, available resources and the like.

In a possible implementation form as a parent device, semantically processing the input data may further comprise that the device is configured to receive, from the one or more child devices, respective positionally encoded semantic information as the input data.

As used herein, a positional encoding may refer to supplementing semantic information by further information which helps a parent device to better relate input data received from different child devices.

In a possible implementation form, the respective positionally encoded semantic information may comprise one or more of: a time stamp, a geographic position, and a unique identifier of the respective device.

In a possible implementation form as a child device or as a parent device, semantically processing the input data may further comprise that the device is configured to determine semantic information of the input data in dependence of the input data and the local context, using a trained attention neural network, ANN, encoder of the device; and to determine semantic facts of the input data in dependence of the semantic information of the input data, using a trained semantic extraction, SE, component of the device.

Advantageously, ANN encoders enable efficient data fusion from multiple sensors or child devices.

As used herein, semantic information may refer to an excerpt of relevant information of the input data of a device.

As used herein, feature vectors may refer to a particular representation of semantic information describing different aspects of the input data. Feature vectors may implicitly capture semantic relations in the input data of a device.

As used herein, an attention neural network (ANN) encoder may refer to a self/cross-attention processing/computing function for capturing semantic relations in the input data (i.e., one or more feature vectors from one or more sensors or one or more child devices). This is invariant to a number and order of input feature vectors, and thus may result in semantic fusion of the input data by capturing semantic relations between the input data originating from more than one source, using local context. In other words, an ANN encoder may output one or more feature vectors which capture said semantic relations through attention mechanism (not explicitly).

As used herein, a semantic extraction (SE) component may refer to a processing/computing function for identifying semantic facts of the input data (i.e., one or more feature vectors from an ANN encoder) in dependence of the semantic information of the input data wherein the semantic facts represent a semantic interpretation of the input data, such as a local scene graph.

In a possible implementation form, the semantic information of the input data may comprise one or more feature vectors of the input data.

The ANN encoder may comprise a Transformer encoder of a Transformer encoder-decoder architecture.

As used herein, a Transformer encoder-decoder architecture may refer to the de-facto standard encoder-decoder architecture in natural language processing, originally being proposed in Vaswani, Ashish, et al. “Attention is all you need.” Advances in neural information processing systems 30 (2017).

As used herein, a Transformer encoder may refer to an encoder portion of a Transformer encoder-decoder architecture.

In a possible implementation form, the Transformer encoder may be pre-trained based on a supervised machine learning paradigm.

As used herein, supervised machine learning may refer to a machine learning paradigm for problems wherein the available data consists of labelled examples. More specifically, supervised learning seeks to train a function that maps feature vectors (inputs) to labels (output), based on example input-output pairs.

In a possible implementation form, the SE component may comprise a Transformer decoder of the Transformer encoder-decoder architecture.

As used herein, a Transformer decoder may refer to a decoder portion of a Transformer encoder-decoder architecture.

In a possible implementation form, the Transformer decoder may be pre-trained based on a supervised machine learning paradigm.

In a possible implementation form, the device may further be configured to participate in a distributed joint training across the parent-child hierarchy of devices based on local training labels for the respective device.

In a possible implementation form as a child device or as a parent device, semantically processing the input data may further comprise that the device is configured to determine a solution of the local goal in dependence of the semantic facts of the input data and the local goal, using a semantic processing, SP, component of the device.

As used herein, a semantic processing (SP) component may refer to a processing/computing function for solving the local goal by analyzing optional decisions from child devices and the semantic facts from the SE component using logical rules and semantic reasoning. As such, the SP component may detect a change of the local context. Further, the SP component may optionally indicate a decision (i.e., a success in solving the local goal) to a parent device.

In a possible implementation form as a parent device, semantically processing the input data may further comprise that the device is configured to receive, from one or more child devices, respective decision flags; and determine the solution of the local goal in dependence of the semantic facts of the input data, the respective decision flags and the local goal, using the SP component of the device.

As used herein, a decision flag may refer to a boolean value representing a success (1) or lack of success (0) in solving the local goal.

In a possible implementation form as a child device, semantically processing the input data may further comprise that the device is configured, upon the solution having a confidence of less than a first confidence threshold, to send, to a parent device of the device, a synchronization flag, or to omit the sending of the synchronization flag.

As used herein, a confidence may refer to a measure of certainty of a decision, such as that solving the local goal was successful or not. The confidence may be expressed as a percentage value ranging from 0% to 100%, respectively.

In a possible implementation form as a child device, semantically processing the input data may further comprise that the device is configured, upon the solution having a confidence in excess of a second confidence threshold, to positionally encode the semantic information of the input data, using a post-processing, PP, component of the device; and to send, to the parent device, the positionally encoded semantic information.

As used herein, a post-processing (PP) component may refer to a post-processing/computing function for turning the semantic information of the input data into a format that may be required by a parent device, including positional encoding (i.e., additional information bits helping the parent device to better relate data coming from different child devices), and for selecting relevant semantic information with respect to the local goal.

In a possible implementation form as a child device, semantically processing the input data may further comprise that the device is configured, upon the solution having a confidence in excess of a third confidence threshold, to send, to the parent device, a decision flag in accordance with the confidence of the solution.

In a possible implementation form as a child device, maintaining the local context may further comprise that the device is configured to determine a change of the local context in dependence of the semantic facts of the input data and the available side information, using the SP component of the device; and upon the change of the local context having a significance in excess of a significance threshold, to adapt the local context in dependence of the semantic facts of the input data and the available side information; and to send, to the parent device, the local context.

As used herein, a significance may refer to a measure of relevance of a change, such as that the local context has changed. The significance may be expressed as a percentage value ranging from 0% to 100%, respectively.

In a possible implementation form, the semantic facts of the input data may be representable as a scene graph; and a change of the scene graph may be indicative of the change of the local context of the device.

As used herein, a scene graph may refer to a semantic network representing semantic facts in a graph-theoretic manner, such as representing all detected objects together with their relations and attributes.

In a possible implementation form as a parent device, maintaining the local context may further comprise that the device is configured to receive, from one or more child devices, respective local contexts; determine the change of the local context in dependence of the received local contexts; and upon the change of the local context having a significance in excess of the significance threshold, to adapt the local context in dependence of the received local contexts; and to send, to the one or more child devices, the adapted local context.

In a possible implementation form as a parent device, participating in the assignment of the respective local goals may further comprise that the device is configured, upon the change of the local context having a significance in excess of the significance threshold, to decompose the local goal into the respective local goals of the one or more child devices in dependence of the local context, using a goal assignment component of the device; and to send, to the one or more child devices, the respective local goal.

As used herein, a goal assignment component may refer to a processing/computing function for translating a local goal which may be composed of multiple sub-goals into local goals to be assigned to the respective child device. Local goals assigned to different child devices may be expressed using different semantic languages. Further, different child devices may be assigned a same sub-goal.

In a possible implementation form as a child device, participating in the assignment of the respective local goals may further comprise that the device is configured to receive, from the parent device, the local goal.

In a possible implementation form, the local goal may be expressed in a common semantic language of the device and the parent device.

In a possible implementation form as a child device, participating in the assignment of the respective local goals may further comprise that the device is configured to determine a potential local goal of the device in dependence of the local training labels and the local context; and to send, to the parent device of the device, the determined potential local goal.

In a possible implementation form as a parent device, participating in the assignment of the respective local goals may further comprise that the device is configured to receive, from the one or more child devices, respective potential local goals; and to send, to the parent device of the device, the respective potential local goals.

In a possible implementation form, the device may comprise a mobile device, such as a mobile phone, autonomous vehicle, and the like.

As used herein, a mobile device may refer to portable electronic equipment having data processing and wireless communication capabilities.

According to a second aspect, a method of operating a device for distributed semantic processing and communication is provided. The device is operable as a child device and/or a parent device in a parent-child hierarchy of devices. The method comprises a step of semantically processing input data in dependence of a local context and a local goal, the input data originating from one or more sensors or one or more child devices of the device. The method further comprises a step of maintaining the local context in dependence of the semantically processed input data and available side information. The method further comprises a step of participating in an assignment of respective local goals of the devices across the parent-child hierarchy in dependence of the local context.

In a possible implementation form, the method may be performed by the device of the first aspect or any of its implementations.

According to a third aspect, a computer program is provided comprising a program code for performing the method of the second aspect or any of its implementations, when executed on a computer.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary scenario of distributed semantic processing and communication in accordance with the present disclosure;

FIGS. 2A and 2B illustrate a client device and a parent device in accordance with the present disclosure;

FIGS. 3A and 3B illustrate an interaction of the devices of FIGS. 2A and 2B in terms of semantic processing of input data;

FIGS. 4A and 4B illustrate an interaction of the devices of FIGS. 2A and 2B in terms of maintaining the local context;

FIGS. 5A and 5B illustrate an interaction of the devices of FIGS. 2A and 2B in terms of participating in an assignment of respective local goals of the devices across the parent-child hierarchy;

FIG. 6 illustrates a flow chart of a method in accordance with the present disclosure of operating a device for distributed semantic processing and communication; and

FIGS. 7A to 7C illustrate an concrete exemplary scenario of distributed semantic processing and communication in accordance with the present disclosure.

### DETAILED DESCRIPTIONS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

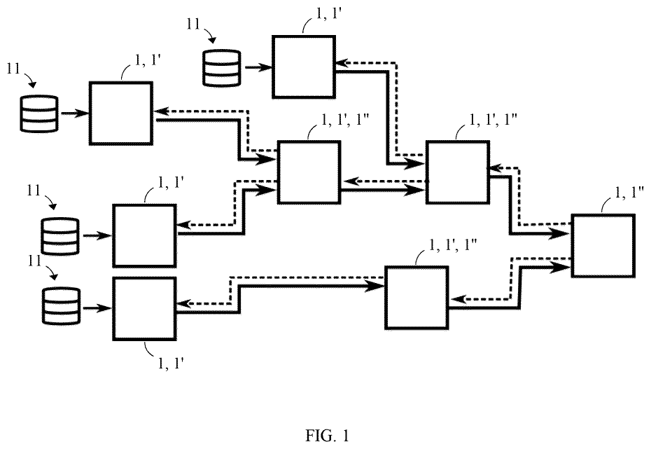

FIG. 1 illustrates an exemplary scenario of distributed semantic processing and communication in accordance with the present disclosure.

We assume some arbitrary multi-hop topology with a variable number of devices 1 (e.g., mobile phones, autonomous vehicles, etc.), possibly some intermediate nodes (e.g., base stations), and a fusion center (FC) 1, 1″ to the right of FIG. 1. The devices 1, 1′ may observe a part of the environment and thereby collect multi-modal data (e.g., videos, audio, etc.). Bi-directional communication between the devices 1 is allowed. On the other hand, we assume that due to communication/privacy constraints, it is not possible or not allowed to share raw data with the FC.

In the exemplary scenario, the FC tries to solve some complex objective (global goal) that is expressible using some suitable compositional language (e.g., logic-based language or graph-based language). Examples of a global goal could be detecting events posing a security risk to pedestrians, determining the root-cause of a road accident, counting specific objects present in an observed scene, and so on. Furthermore, a global goal may comprise multiple sub-goals, and it may change over time. It can be noticed that to solve such global goals, the FC may not only correctly interpret observed data, but also perform semantic reasoning using logical rules and some context/background knowledge. Therefore, solving the goal goes beyond traditional classification/regression tasks and obtaining a complete scene graph representing all detected objects together with their relations and attributes.

Efficient semantic processing and communication depends on a distribution of suitable local goals to every device 1 in the network, which in turn may require some accurate knowledge about the usefulness of each device 1 for solving the global goal. The usefulness of the devices 1 can be assessed easily when the distributed topology is static, i.e., we have a fixed number of devices 1 in the network and their relative positions and orientations are always the same. In such situations, the pattern of local views seen jointly by all sensors remains the same during training and inference phases. As a result, the parent devices 1, 1″ may learn to assign proper goals through suitable calibration and training of neural networks during the training phase.

However, goal assignment (and semantic processing) becomes more challenging when edge nodes are independent and mobile. It is because the usefulness of each device 1 for solving the global goal depends also on its position and orientation in the environment and its relation to other devices 1. In a naive approach, one may try to re-train and re-calibrate the network of FIG. 1 each time the topology changes significantly. However, this becomes very difficult, if not impossible, when the number and position or orientation of the devices 1 changes frequently. It is because the local views of the devices 1 jointly form a pattern which constantly evolves over time.

The problem to be solved is to find suitable signaling, encoding, and decoding procedures that allow the FC to efficiently solve its global goal, without a direct access to raw data collected by a variable number of mobile sensors with a dynamic pattern of views.

Solving this problem is associated with several technical challenges. Firstly, edge devices 1, 1′ and intermediate devices 1, 1′, 1″ which observe only partial data should be able to properly extract semantically relevant information from said data with respect to the global goal. Furthermore, suitable sub-goal assignment may require accurate and up-to-date knowledge about the current state of the system and of the observed environment. Finally, the extracted semantic information should be robustly fused/processed at a parent device 1, 1″ despite a varying number of mobile devices 1.

The kind of distributed semantic processing and communication proposed in the following is therefore in support of
a variable number of mobile devices 1,
reduced communication costs and enhanced privacy compared with a situation in which data collected by the devices 1 are sent uncompressed to the FC,
significantly improved performance (e.g., lower latency, robustness, flexibility, and energy consumption) compared with general-purpose distributed learning techniques such as plain INL, while enabling efficient data fusion from multiple sensors, and
robustness to dynamic changes of the pattern of views, and not requiring costly re-training or re-calibration whenever the topology changes.

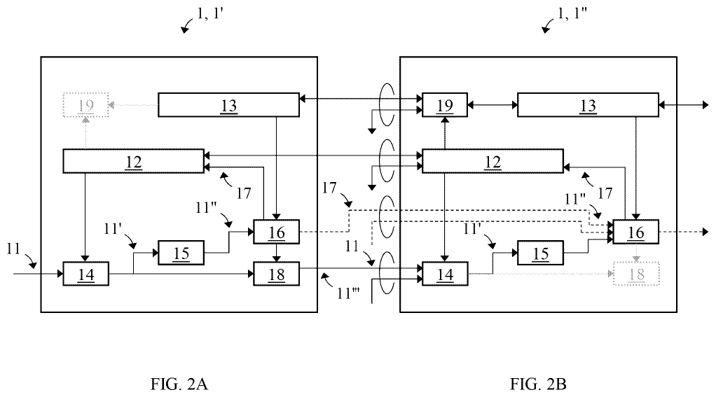

FIGS. 2A and 2B illustrate a client device 1, 1′ and a parent device 1, 1″ in accordance with the present disclosure.

The respective device 1 may comprise a mobile device, such as a mobile phone, autonomous vehicle, and the like, or a fixed device, such as a base station, access point, and the like.

The respective device 1 is suited for distributed semantic processing and communication and operable as a child device 1′ and/or a parent device 1″ in a parent-child hierarchy of devices 1. FIG. 2A and FIG. 2B collectively render a smallest possible parent-child hierarchy of devices 1.

The respective device 1 may comprise local context 12 and a local goal 13, an attention neural network (ANN) encoder 14, a semantic extraction (SE) component 15, a semantic processing (SP) component 16, a post-processing (PP) component 18, and a goal assignment component 19.

A respective implementation of these processing/computing functions may include general-purpose processor hardware and/or software unless specified otherwise below.

Also a respective operation of these processing/computing functions will be explained in more detail below. As an abstract,
the respective device 1 may be configured to participate 21 in a distributed joint training across the parent-child hierarchy of devices 1 based on local training labels for the respective device 1;
the respective device 1 is configured to semantically process 22 input data 11 in dependence of the local context 12 and the local goal 13. The input data 11 originates from one or more sensors or one or more child devices 1′ of the device 1;
the respective device 1 is further configured to maintain 23 the local context 12 in dependence of the semantically processed input data, which relates to the semantic information 11′ of the input data 11, the semantic facts 11″ of the input data 11, and the decision flag 17 explained below, and available side information, and
the respective device 1 is further configured to participate 24 in an assignment of respective local goals 13 of the devices 1 across the parent-child hierarchy in dependence of the local context 12.

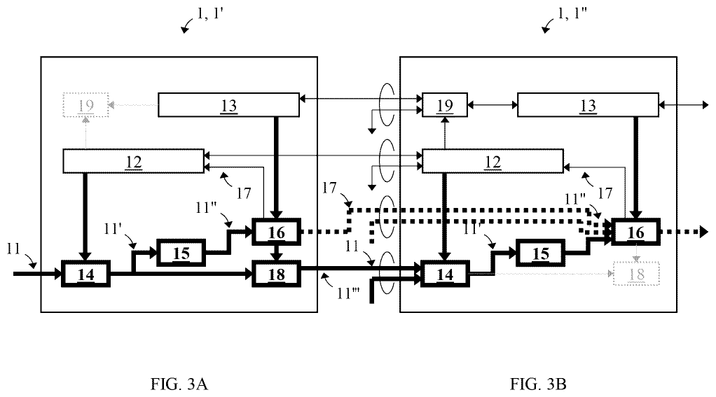

FIGS. 3A and 3B illustrate an interaction of the devices 1, 1′, 1″ of FIGS. 2A and 2B in terms of semantic processing of input data 11.

### Semantic Attention-Based Processing at Child Devices

A child device 1′ processes its obtained input/sensed data 11 using its Attention-based neural network (ANN) 14 in view of its local context 12. The output of ANNs 14 are feature vectors which contain relevant semantic information 11′ from the input/sensed data 11. The obtained feature vectors are then processed by SE and SP components 15, 16 in order to solve the local goal 13.

If the local goal 13 of the child device 1′
cannot be validated with high confidence, then the device sends nothing (or just a synchronization flag),
could be validated, then the node sends post-processed semantic features 11″ (e.g., with appended positional encoding), possibly with some related symbolic facts/data, and
can be validated with high confidence, then the child device may optionally send a decision flag 17 and possibly some related data/features to the parent device,

So, as a child device 1′ or as a parent device 1″, semantically processing 22 the input data 11 may comprise that the device 1 is configured to determine 2202 semantic information 11′ of the input data 11 in dependence of the input data 11 and the local context 12, using a trained attention neural network, ANN, encoder 14 of the device 1; and to determine 2203 semantic facts 11″ of the input data 11 in dependence of the semantic information 11′ of the input data 11, using a trained semantic extraction, SE, component 15 of the device 1.

The semantic information 11′ of the input data 11 may comprise one or more feature vectors of the input data 11.

The ANN encoder 14 may comprise a Transformer encoder of a Transformer encoder-decoder architecture.

The SE component 15 may comprise a Transformer decoder of the Transformer encoder-decoder architecture.

The Transformer decoder and the Transformer encoder may respectively be pre-trained based on a supervised machine learning paradigm.

Further, as a child device 1′ or as a parent device 1″, semantically processing 22 the input data 11 may further comprise that the device 1 is configured to determine 2204 a solution of the local goal 13 in dependence of the semantic facts 11″ of the input data 11 and the local goal 13, using a semantic processing, SP, component 16 of the device 1.

It should be noted that the joint role of the SE and SP components 15, 16 is also to evaluate a relevance of the input data 11 with respect to the local sub-goal 13. Without these components, a child device 1′ cannot assess the usefulness of its input data 11 and risks sending irrelevant data to the parent device 1″. This leads to inefficient usage of scarce communication bandwidth.

As a child device 1′, semantically processing 22 the input data 11 may further comprise that the device 1 is configured, upon the solution having a confidence of less than a first confidence threshold, to send 2207, to a parent device 1″ of the mobile edge device 1, a synchronization flag, or to omit 2208 the sending of the synchronization flag. The first confidence threshold may amount to 50%, for instance.

Further, as a child device 1′, semantically processing 22 the input data 11 may further comprise that the device 1 is configured, upon the solution having a confidence in excess of a second confidence threshold, to positionally encode 2209 the semantic information 11′ of the input data 11, using a post-processing, PP, component 18 of the device 1; and to send 2210, to the parent device 1″, the positionally encoded semantic information 11″′. The second confidence threshold may amount to 90%, for instance.

It should be noted that the positional encoding appended by child devices 1′ helps the parent device 1″ to better relate data from multiple child devices 1′ (by removing possible ambiguities). The encoding may contain, e.g., the sensor's GPS position, time-stamp, and device's ID.

Further, as a child device 1′, semantically processing 22 the input data 11 may further comprise that the device 1 is configured, upon the solution having a confidence in excess of a third confidence threshold, to send 2211, to the parent device 1″, a decision flag 17 in accordance with the confidence of the solution. The third confidence threshold may amount to 97%, for instance.

### Semantic Attention-Based Processing at Parent Devices

A parent device 1″ attempts to combine and processes decision flags 17 received from its child devices 1′, if any, in order to validate its local goal 13.

If the local goal 13 cannot be validated, the parent device 1″ feeds received positionally encoded semantic information 11″′ into its ANN encoder 14.

The ANN encoder 14 is able to fuse input data 11 from a variable number of child devices 1′ due to unique properties of Transformers with Attention:
being invariant to the number and order of received feature vectors,
using the self/cross-attention mechanism and local context 12 to detect semantic correlations between the input data 11 received from different child devices 1′ (e.g., common semantic cues, same background/objects, etc.),
relying on the positional encoding appended by child devices 1 to enhance reliability,
helping to produce richer outputs (e.g., scene graphs) at the SE component of the parent device 1″ than local ones produced at child devices 1′, because semantic fusion
   possibly unveils new objects that are either partially, or not at all, inferred from each view locally,
   possibly unveils new attributes or relations among objects, and
   possibly refines existing attributes or relations among objects.

The fused semantic features 11′ are then processed by the SE and SP components 15, 16 in order to solve the local goal 13.

It should be noted that validating the local goal 13 at a parent device 1″ may require multi-round communication between the parent device 1″ and any of its child devices 1′. It may be helpful, for example, when the parent device 1″ may require more evidence to validate its local goal 13, or when the parent device 1″ decides to re-assign sub-goals based on information already provided by other child devices 1′.

So, as a parent device 1″, semantically processing 22 the input data 11 may comprise that the device 1 is configured to receive 2205, from one or more child devices 1′, respective decision flags 17; and determine 2206 the solution of the local goal 13 in dependence of the semantic facts 11″ of the input data 11, the respective decision flags 17 and the local goal 13, using the SP component 16 of the device 1.

Further, as a parent device 1″, semantically processing 22 the input data 11 may further comprise that the device 1 is configured to receive 2201, from the one or more child devices 1′, respective positionally encoded semantic information 11″′ as the input data 11.

The respective positionally encoded semantic information 11″′ may comprise one or more of: a time stamp, a geographic position, and a unique identifier of the respective device 1.

As a child device 1′ or as a parent device 1″, semantically processing 22 the input data 11 may comprise that the device 1 is configured to determine 2202 semantic information 11′ of the input data 11 in dependence of the input data 11 and the local context 12, using a trained attention neural network, ANN, encoder 14 of the device 1; and to determine 2203 semantic facts 11″ of the input data 11 in dependence of the semantic information 11′ of the input data 11, using a trained semantic extraction, SE, component 15 of the device 1.

The semantic information 11′ of the input data 11 may comprise one or more feature vectors of the input data 11.

The ANN encoder 14 may comprise a Transformer encoder of a Transformer encoder-decoder architecture.

The SE component 15 may comprise a Transformer decoder of the Transformer encoder-decoder architecture.

The Transformer decoder and the Transformer encoder may respectively be pre-trained based on a supervised machine learning paradigm.

Further, as a child device 1′ or as a parent device 1″, semantically processing 22 the input data 11 may further comprise that the device 1 is configured to determine 2204 a solution of the local goal 13 in dependence of the semantic facts 11″ of the input data 11 and the local goal 13, using a semantic processing, SP, component 16 of the device 1.

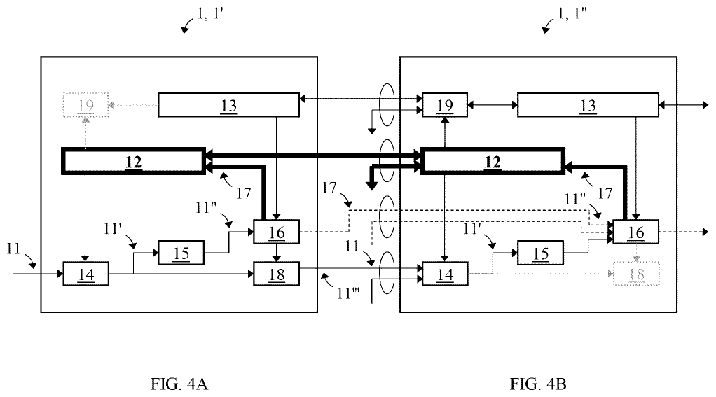

FIGS. 4A and 4B illustrate an interaction of the devices 1, 1′, 1″ of FIGS. 2A and 2B in terms of maintaining the local context 12.

As used herein, local context 13 may refer to information about a state and observed environment of a device 1 within the parent-child hierarchy of devices 1. Context may serve to properly interpret input data 11 and to assign local goals 13 to child devices 1′. For example, context may include built-in or learnt background knowledge, sensor parameters (type, position, etc.), general settings (weather, time, holidays, etc.), current pattern of views, a position of the device 1 with respect to other devices 1, partial semantic information provided by other devices 1 (including already detected objects with attributes), and the like. Context may constantly evolve due to mobility of devices and due to changes in the observed environment. Possible events causing significant changes of context include devices getting in/out of the parent-child hierarchy of devices 1, changed relative pattern of views (e.g., caused by rotation of a sensor), displacement of one or more sensors into a new area (e.g., from a street to a park), change in the capabilities of the device (e.g., low battery), significant changes in the environment (e.g., intensive rain, diurnal changes, etc.) and the like.

When a change of local context 13 occurs, the local goals 13 assigned to any of the devices 1 may become sub-optimal or even unsolvable. Furthermore, non-updated context may lead to a wrong interpretation of received input data 11 by the device 1 (e.g., a car on a street should be differently interpreted than a car in a park). Therefore, detection of the changed context and its frequent update is a crucial task.

Detection of a context change can be done by any device 1 by analyzing
received input data 11 (input/sensed data at child devices 1′ or processed data at parent devices 1″),
obtained side information, e.g., the number of registered devices, their GPS locations, battery level, etc.

Detection of the changed context may particularly be based on evaluating the evolution of scene graphs output of SE components 15 either at child devices 1′ or at parent devices 1″. Once the change of context is detected, the device 1 uses the acquired information to update its local model of context 12. Next, the device 1 may communicate the updated context to directly connected devices 1 (i.e., child devices 1′ and/or parent devices 1″).

So, as a child device 1′, maintaining 23 the local context 12 may comprise that the device 1 is configured to determine 2301 a change of the local context 12 in dependence of the semantic facts 11″ of the input data 11 and the available side information, using the SP component 16 of the device 1; and upon the change of the local context 12 having a significance in excess of a significance threshold, to adapt 2302 the local context 12 in dependence of the semantic facts 11″ of the input data 11 and the available side information; and to send 2303, to the parent device 1″, the local context 12.

The semantic facts 11″ of the input data 11 may be representable as a scene graph; and a change of the scene graph may be indicative of the change of the local context 12 of the device 1.

As a parent device 1″, maintaining 23 the local context 12 may further comprise that the device 1 is configured to receive 2304, from one or more child devices 1′, respective local contexts 12; determine 2305 the change of the local context 12 in dependence of the received local contexts 12; and upon the change of the local context 12 having a significance in excess of the significance threshold, to adapt 2306 the local context 12 in dependence of the received local contexts 12; and to send 2307, to the one or more child devices 1′, the adapted local context 12.

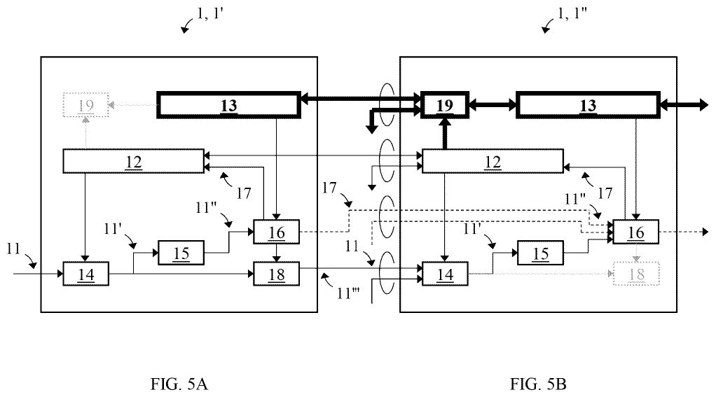

FIGS. 5A and 5B illustrate an interaction of the devices 1, 1′, 1″ of FIGS. 2A and 2B in terms of participating in an assignment of respective local goals 13 of the devices 1, 1′, 1″ across the parent-child hierarchy.

In accordance with the present disclosure, a mechanism is proposed which translates a global goal at the FC into local goals 13 by progressively assigning local goals 13 to each device 1 in the network. It is assumed that the global goal is given to or formed at the FC. For example, it can be provided by a human operator as a natural language query, and then automatically parsed into a formula in some suitable machine-oriented semantic language. The global goal at the FC may automatically be decomposed into sub-goals to be assigned to its child devices 1′. To maintain generality of the solution, no particular algorithm for decomposing global goals into sub-goals is provided. Nonetheless, it should be noted that a suitable assignment of sub-goals should take into account:
usefulness of input data 11 that can be acquired by a child device 1′,
processing capabilities of a device 1 (e.g., the ability to extract specific types of facts from its input data 11),
available context/background knowledge (e.g., some domain-specific knowledge or implicitly learnt knowledge about the usefulness of a device 1 for solving a particular task).

The sub-goals are assigned and communicated to proper child devices 1′. If these devices 1 have their own child devices 1′, they may translate the obtained local goal 13 further and assign new respective sub-goals to their child devices 1′ using the method described above. This may be repeated recursively until all devices 1 in the network possess a local goal 13.

Similarly to global goals, local goals 13 may consist of multiple sub-goals. Furthermore, multiple child nodes 1′ may be assigned identical sub-goals. Finally, an assigned sub-goal should be expressed in a semantic language that is understood by a child device 1. This may require that each pair of directly connected devices 1 agrees on a common semantic language used for communication.

When the local context 12 of a parent device 1″ changes, the device 1 re-evaluates its goal assignment. If needed, the device 1 may update the goal assignment. This may include assigning sub-goals to new devices 1 that get in, or updating/refining the sub-goals to already registered devices 1.

It should be noted that a basic assumption is that child and parent devices 1′, 1″ share a common semantic language used to interpret assigned local goals 13. Each child-parent pair may use a different semantic language.

So, as a child device 1′, participating 24 in the assignment of the respective local goals 13 may comprise that the device 1 is configured to receive 2505, from the parent device 1″, the local goal 13.

The local goal 13 may be expressed in a common semantic language of the device 1 and the parent device 1.

Further, as a parent device 1″, participating 24 in the assignment of the respective local goals 13 may further comprise that the device 1 is configured, upon the change of the local context 12 having a significance in excess of the significance threshold, to decompose 2406 the local goal 13 into the respective local goals 13 of the one or more child devices 1′in dependence of the local context 12, using a goal assignment component 19 of the device 1; and to send 2407, to the one or more child devices 1′, the respective local goal 13.

### Learning to Assign Goals

Progressive assignment of local goals to each device 1 in the network so that all devices 1 can contribute to solving a global goal is a particularly crucial task. However, this may require that parent devices 1″ know what kind of queries could be answered by their child devices 1′.

The simplest solution is to manually pre-encode the set of possible local goals 13 of each device 1 by a human operator. While conceptually simple, however, this approach may become impractical in large networks with hundreds of devices 1.

A more practical discovery procedure is to use the training dataset to progressively build and propagate a set of possible goals from the edge devices 1 to the FC. In a first step, each edge device 1 may use its local training labels and local background knowledge to build a set of possible local goals 13 which the device I would be able to validate. The background knowledge can be pre-encoded or learnt from data. The obtained set of possible local goals 13 may then be communicated to the parent device 1″, which may in turn build its own set of possible local goals 13 and forward it to its own parent device 1. The procedure may be repeated until the FC is reached.

During goal assignment, a parent device 1 may check whether its local goal 13 (or part of it) belongs to the set of possible local goals 13 of the respective child node 1′. If so, then the parent device 1″ may assign a sub-goal to the child device 1′.

Further, a mechanism of implicit learning (learning from examples) may be used to enrich the local context/background knowledge of a device 1. During inference phase, a device 1 may observe many examples from which it may derive some new facts and relations which do not appear in the training dataset. If the updated background knowledge helps to solve some new goals by the device 1, this information should be communicated to the parent device 1″ and then propagated until the FC is reached.

So, as a child device 1′, participating 24 in the assignment of the respective local goals 13 may comprise that the device 1 is configured to determine 2401 a potential local goal 13 of the device 1 in dependence of the local training labels and the local context 12; and to send 2402, to the parent device 1″ of the device 1, the determined potential local goal 13.

Further, as a parent device 1″, participating 24 in the assignment of the respective local goals 13 may comprise that the device 1 is configured to receive 2403, from the one or more child devices 1′, respective potential local goals 13; and to send 2404, to the parent device 1″ of the device 1, the respective potential local goals 13.

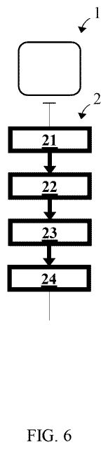

FIG. 6 illustrates a flow chart of a method 2 in accordance with the present disclosure of operating a device 1 for distributed semantic processing and communication.

As mentioned previously, the device 1 is operable as a child device 1′ and/or a parent device 1″ in a parent-child hierarchy of devices 1.

The method 2 may comprise a step of participating 21 in a distributed joint training (more specifically, supervised joint training using in-network learning) across the parent-child hierarchy of devices 1 based on local training labels for the respective device 1.

Full training of Transformers usually may require considerable amount of training data and significant computational power. To overcome this technical challenge, a common approach is to pre-train a general-purpose model in the off-line environment, using a large training dataset, and then fine-tune the pre-trained model to perform more specific tasks based on a relatively small number of training samples. Initially, suitable training samples may be loaded to respective edge (i.e., child-only) devices (e.g., images, videos, audio signals, etc.). In addition, proper training labels may be loaded to each node in the network. The training labels at each device help to train respective SE components to extract relevant semantic facts from the input data. Next, a distributed joint training using a multi-task loss function may be performed. In the forward pass, edge devices pass their input data through their neural networks with attention. The activation values output by respective SE components are used to compute the value of the local loss function, and the activation values output by respective Attention encoders are forwarded to the respective parent device. The respective parent device combines received activation values and feeds them into its own neural networks with attention. Similarly as before, the activation values output by the SE component are used to compute the local loss, and the activation values output by the Attention encoder are sent to the following node. The procedure is continued until the FC is reached. The backward pass essentially reverses the operations done in the forward pass. The error vector at the input of each neural network (NN) is split by reversing the “combine” operation. The obtained split vectors are then distributed to respective child nodes. The procedure is continued until each edge node processes the error vectors and updates the weights of their respective neural networks. The forward and backward passes are repeated until convergence of all NNs.

The method 2 comprises a step of semantically processing 22 input data 11 in dependence of a local context 12 and a local goal 13, the input data 11 originating from one or more sensors or one or more child devices 1′ of the device 1.

The method 2 further comprises a step of maintaining 23 the local context 12 in dependence of the semantically processed input data and available side information.

The method 2 further comprises a step of participating 24 in an assignment of respective local goals 13 of the devices 1 across the parent-child hierarchy in dependence of the local context 12.

The method 2 may be performed by the device 1, 1′, 1″ of the first aspect or any of its implementations.

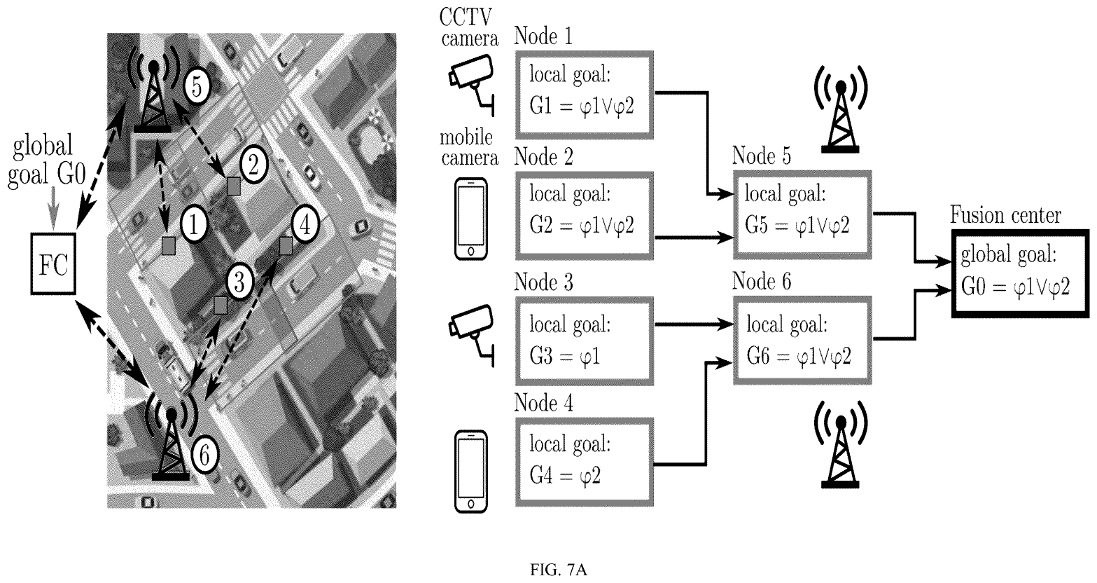

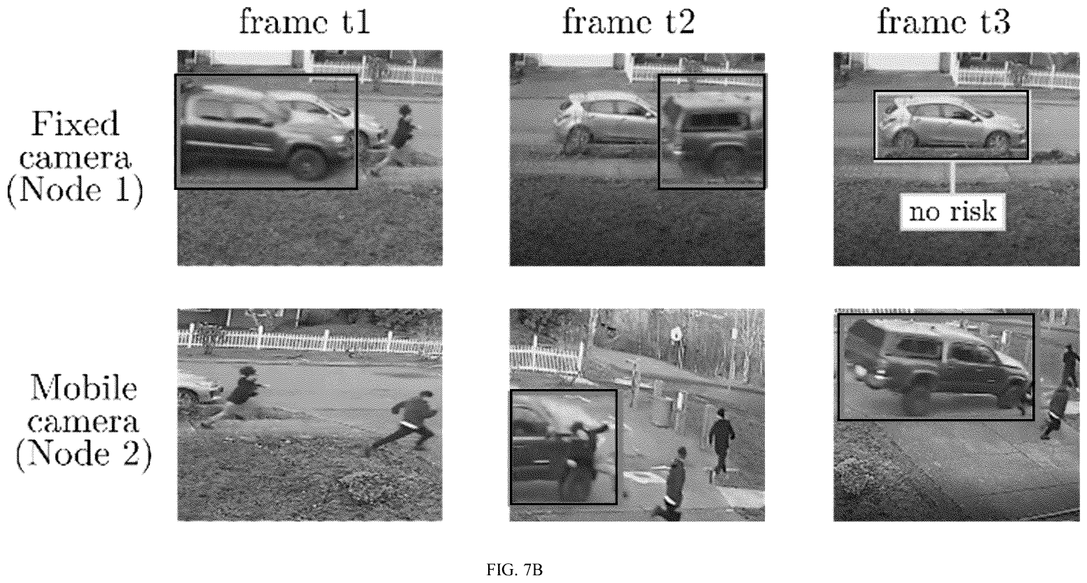

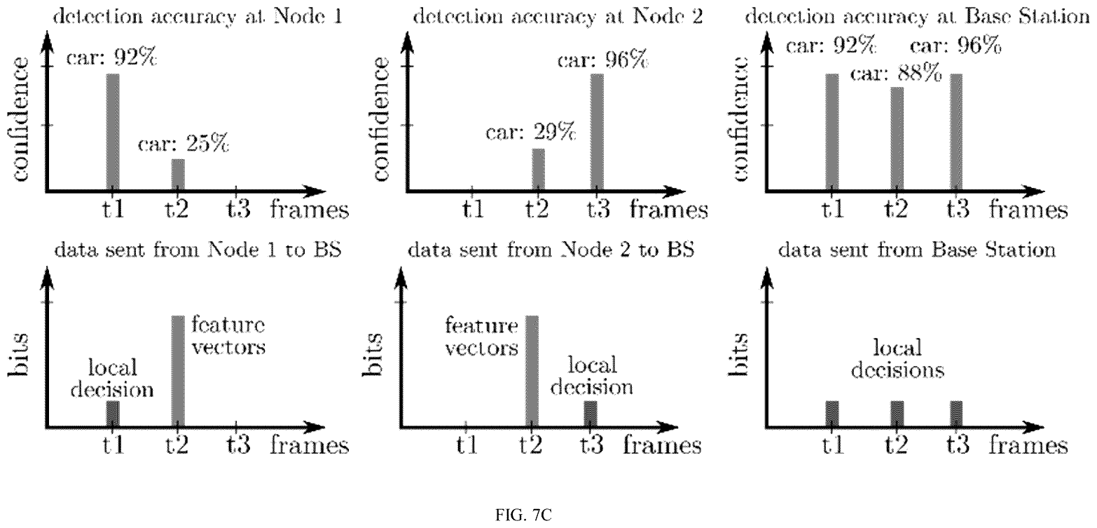

FIGS. 7A to 7C illustrate an concrete exemplary scenario of distributed semantic processing and communication in accordance with the present disclosure, namely safety monitoring in a pedestrian area.

FIG. 7A depicts a bird's eye view of the exemplary scenario and the corresponding parent-child hierarchy of devices 1. The parent-child hierarchy includes four edge (i.e., child-only) devices \textcircled{1}-\textcircled{4} equipped with a video camera, two base stations (intermediate devices) \textcircled{5}-\textcircled{6}, and a remote fusion center (FC).

Each device 1 in the parent-child hierarchy shown in FIGS. 7A has local goals assigned as indicated, wherein G0= 1∨φ2 represents the global goal at the FC and φ1, φ2 sub-goals. For example, sub-goal φ1 may denote a sentence “there is a moving car on the pedestrian area”, sub-goal φ2 may denote a sentence “there is a person holding a gun”, and “∨” represents a logical OR operation.

FIG. 7B depicts frames of videos recorded by cameras at device \textcircled{1} (static camera) and device \textcircled{2} (mobile camera) at three different time steps t1, t2, and t3 (left side). Note that the observed areas partially overlap, and that the view of device \textcircled{2} changes over time. The frames illustrate a moving car which poses a security risk to pedestrians. FIG. 7B further shows a communication between the devices (right side).

At the time step t1, only device \textcircled{1} observes the car. The device 1, which is capable of solving the sub-goal φ1, evaluates its collected data and decides with high confidence that the observed car poses a risk to security in the pedestrian area. Therefore, it sends a decision flag 17 to parent device \textcircled{5} to report the event. At the same time, device \textcircled{2} does not observe any car and thus remains silent.

At the time step t2, the car moved forward and now it is partially observed by both devices \textcircled{1}, \textcircled{2}. Devices \textcircled{1}, \textcircled{2} detect the car, but are unable to assess with high confidence whether the car poses a risk to security. Therefore, instead of sending a decision flag 17, both devices 1 send feature vectors (processed data) output by their respective ANN encoders 14 to parent device \textcircled{5}. The intermediate device receives the feature vectors and performs semantic fusion. By taking into account common semantic cues in the data provided by the devices \textcircled{1}, \textcircled{2} (e.g., color/size of a car, same white fence in the background), the intermediate device determines that both devices \textcircled{1}, \textcircled{2} observe the same car. The joint evaluation of the input data 11 helps device \textcircled{5} to determine with high confidence the presence of an unauthorized car. Therefore, it sends a decision flag 17 to the fusion center.

At the time step t3, the car moved forward again and it is visible only by device \textcircled{2}. The device 1 sends a decision flag 17 to its parent device \textcircled{5}, while device \textcircled{1} remains silent. It can be noticed that device \textcircled{1} observes another car, which is outside the pedestrian area and therefore does not pose a risk to security. Therefore, the presence of the car is not reported.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A device for distributed semantic processing and communication, the device being operable as a child device and/or a parent device in a parent-child hierarchy of devices, the device comprising a hardware processor configured to:
semantically process input data based on a local context and a local goal, the input data originating from one or more sensors or one or more child devices of the device;
maintain the local context based on the semantically processed input data and available side information; and
participate in an assignment of respective local goals of the devices across the parent-child hierarchy based on the local context.

2. The device of claim 1,
wherein the device is configured as the parent device, and the hardware processor, for semantically processing the input data, is further configured to
receive, from the one or more child devices, respective positionally encoded semantic information as the input data.

3. The device of claim 2, wherein
the respective positionally encoded semantic information comprises one or more of:
a time stamp,
a geographic position, and
a unique identifier of the respective device.

4. The device of claim 1,
wherein the device is configured as the child device or as the parent device, and for semantically processing the input data, is further configured to:
determine semantic information of the input data based on the input data and the local context, using a trained attention neural network (ANN) encoder of the device; and
determine semantic facts of the input data based on the semantic information of the input data, using a trained semantic extraction (SE) component of the device.

5. The device of claim 4,
wherein the semantic information of the input data comprises one or more feature vectors of the input data.

6. The device of claim 4,
wherein the trained ANN encoder comprises a transformer encoder of a transformer encoder-decoder architecture.

7. The device of claim 6,
wherein the transformer encoder is pre-trained based on a supervised machine learning paradigm.

8. The device of claim 4,
wherein the trained SE component comprises a transformer decoder of a transformer encoder-decoder architecture.

9. The device of claim 8,
wherein the transformer decoder is pre-trained based on a supervised machine learning paradigm.

10. The device of claim 9, wherein the hardware processor is further configured to:
participate in a distributed joint training across the parent-child hierarchy of devices based on local training labels for the respective device.

11. The device of claim 4,
wherein the device is configured as the child device or as the parent device, and semantically processing the input data further comprises that the hardware processor is configured to:
determine a solution of the local goal based on the semantic facts of the input data and the local goal, using a semantic processing (SP) component of the device.

12. The device of claim 11,
wherein the device is configured as the parent device, and semantically processing the input data further comprises that the hardware processor is configured to:
receive, from one or more child devices, respective decision flags; and
determine the solution of the local goal based on the semantic facts of the input data, the respective decision flags and the local goal, using the SP component of the device.

13. The device of claim 11,
wherein the device is configured as the child device, and semantically processing the input data further comprises that the hardware processor is configured to:
based on the solution having a confidence of less than a confidence threshold;
send, to a parent device of the device, a synchronization flag, or
omit sending of the synchronization flag.

14. The device of claim 11,
wherein the device is configured as the child device, and semantically processing the input data further comprises that the hardware processor is configured to:
based on the solution having a confidence in excess of a confidence threshold;
positionally encode the semantic information of the input data, using a post-processing (PP) component of the device; and
send, to the parent device, the positionally encoded semantic information.

15. The device of claim 11,
wherein the device is configured as the child device, and semantically processing the input data further comprises that the hardware processor is configured to:
based on the solution having a confidence in excess of a confidence threshold,
send, to the parent device, a decision flag in accordance with the confidence of the solution.

16. The device of claim 11,
wherein as a child device, maintaining the local context further comprises that the device is configured to:
determine a change of the local context based on the semantic facts of the input data and the available side information, using the SP component of the device; and
based on the change of the local context having a significance in excess of a significance threshold;
adapt the local context based on the semantic facts of the input data and the available side information; and
send, to the parent device, the local context.

17. The device of claim 16, wherein:
the semantic facts of the input data are representable as a scene graph; and
a change of the scene graph being indicative of the change of the local context of the device.

18. The device of claim 1, comprising
a mobile device.

19. A method of operating a device for distributed semantic processing and communication, the device being operable as a child device and/or a parent device in a parent-child hierarchy of devices;
the method comprising:
semantically processing input data in based on a local context and a local goal, the input data originating from one or more sensors or one or more child devices of the device;
maintaining the local context based on the semantically processed input data and available side information; and
participating in an assignment of respective local goals of the device across the parent-child hierarchy based on the local context.

20. A non-transitory computer-readable storage medium comprising instructions which, when executed by a computer hardware of a device, cause the device to:
semantically process input data based on a local context and a local goal, the input data originating from one or more sensors or one or more child devices of the device;
maintain the local context based on the semantically processed input data and available side information; and
participate in an assignment of respective local goals of the device across a parent-child hierarchy based on the local context.
